(19) United States
(12) Patent Application Publication
(10) Pub. No.: US 2018/0216375 A1
(43) Pub. Date: Aug. 2, 2018

(54) ROLLER TONGUE

(71) Applicant: EMKA Beschlagteile GmbH & Co. KG, Velbert (DE)

(72) Inventor: Roman Jung, Duisburg (DE)

(21) Appl. No.: 15/879,085

(22) Filed: Jan. 24, 2018

(30) Foreign Application Priority Data
Jan. 27, 2017 (EP) 17 153 467.0

(51) Int. Cl. E05C 3/06; E05B 63/00

(52) U.S. Cl. CPC E05C 3/06; E05B 17/007; E05B 63/0013

(57) ABSTRACT

A roller tongue (1) for a locking system includes a spindle, which is securable to the locking system, and a roller (2) rotatably mounted on the spindle. The spindle is formed as a multi-part element and includes a pin (3) and an adapter element (4). The adapter element (4) includes a receiver (5) for the pin (3) arranged eccentrically in the adapter element (4) and is fixable in different orientations onto the pin (3).

### CROSS-REFERENCE TO RELATED APPLICATIONS

The present application claims priority to European Patent Application EP 17 153 467.0, filed Jan. 27, 2017.

### BACKGROUND OF THE INVENTION

The present invention relates to a roller tongue for a locking system with a spindle, which is attachable to the locking system, and with a roller that is rotatably mounted onto the spindle. The invention relates further to a locking system with such a roller tongue.

Roller tongues are used in particular with locking systems for insulating doors, which closed temperature-controlled system interiors, such as, for example, housings of air conditioning, ventilation and heating systems. The roller tongue is thus mounted to the locking system, such that the roller tongue engages in a closed position of the locking system behind a door frame. With a inwardly opened door, the roller tongue is therefore mounted on the outside of the door on the locking system, while with an outwardly opening door, the roller tongue is mounted on the inside of the door on the locking system. Based on the rotational position of the roller, only minimal friction must be overcome, when the roller rolls over the doorframe during the opening or closing process. Since with opening or closing, hardly any friction exists between the roller and the door frame, the surface of the door frame is not scratched.

With air conditioning chambers, it is desirable, however, that the gap between the wing of the door and the doorframe has a predetermined distance for sufficient compression of a seal arranged in the gap. This distance, for example, can be varied according to manufacturing tolerances of the assembly and/or the location of the structure, so that it is desirable that the roller tongue is fixable with difference distances to the door leaf. In this regard, it is known, for example, that the shaft of the roller tongue is mounted to an attachment element, on which the roller tongue is adjustable linearly and is fixable at different distances.

### SUMMARY OF THE INVENTION

An object of the present invention, therefore, is to provide an alternative to the known roller tongue, with which the distance between the roller and door surface is adjustable in a simple manner.

In particular, the object of the present invention is resolved by a roller tongue with the above-noted features, in which the spindle is formed in multiple parts and includes a pin as well as an adapter element, formed in particular, cylindrically, whereby the adapter element includes an axially extending receiver arranged eccentrically in the adapter element for receiving the pin and is fixable in different orientations on the pin.

The invention contemplates its basic idea that the (virtual) axis of rotation of the roller mounted directly and rotatably on the adapter element is offset parallel to the pin, whereby the adapter element that receives the pin in the receiver is fixable in different rotational positions to the pin, so that the distance of the roller to a door surface is changeable depending on the rotational position of the adapter element to the pin.

The spindle, in principle, can include further components in addition to the adapter element and the pin; however, it is preferable that the spindle includes only the pin and the adapter element. The adapter element, in particular, has a cylindrical surface in the region in which the roller is rotatably mounted onto the adapter element. It is not necessary however, that the surface in this region is formed to be continuous. The receiver extending, in particular, axially to this cylindrical section is arranged eccentrically to the axis of symmetry of the substantially cylindrical surface section. The receiver, therefore, is arranged radially offset to the axis of symmetry of the adapter element.

The shape of the receiver is complementary to the shape of the pin. The pin, and therewith also the receiver, can be multi-sided or round in cross-section, for example. For a freely adjustable orientation of the adapter element on the pin, the cross section of the pin and the receiver is circular. However, in principal, it is also possible that the pin and the receiver have a multi-sided cross section, so that the adapter element is insertable in discrete orientations onto the pin. Suitable means are provided with which the adapter element is fixable onto the pin.

In particular, with a circular formation of the pin, the adapter element is fixable by means of an attachment element to the pin, which prevents a rotation of the adapter element relative to the pin. The attachment element, preferably formed as a screw, engages through a hole on the face of the adapter element in a recess, formed in particular as an inner threading, in the face of the pin. The attachment element formed as a screw, in particular, can prevent rotational movement as well as axial movement of the adapter element.

In particular, with a pin formed with multiple sides, the adapter element is securable by means of an attachment element to the pin, which, in particular, only delimits an axial movement of the adapter element on the pin. The attachment element, for example, is a tension ring, which is arranged in a groove formed in the pin and is mounted to the pin after displacement of the adapter element.

The attachment element, in particular, is arranged on the free side of the roller tongue, that is, on the side opposite the attachment of the roller tongue to the locking system, so that the adapter element is readily accessible after assembly on the locking system as well as after mounting the locking system to a door. Thus, the distance between the roller and the door surface can be changed easily at a later time.

An independent invention that does not depend on the multi-part embodiment of the spindle is also contemplated, in which the roller, in particular, is directly, rotatably mounted on the spindle or the adapter element, and by means of a radially moveable snap element, is secured to the spindle or to the adapter element against axial movement. Preferably, the snap element is formed as a hook on the adapter element, which is movable radially inwardly into the receiver. By providing a snap element, the roller can be displaced easily onto the adapter element or the spindle, whereby, upon displacement, the snap element is moved radially inward. In the displaced position, the element snaps back based on its tensioning and engages the roller with a stop, so that this cannot be removed without manually moving of the snap element from the adapter element or the spindle. After displacement of the adapter element onto the pin, the snap element no longer can be moved into the receiver, since this is occupied by the pin. The snap element is thereby fixed.

Preferably, the roller is mounted directly and rotatably on the adapter element, whereby the adapter element has multiple recesses running in the circumferential direction. The recesses run, in particular, only over a part of the circumference. Alternatively, the adapter element could also have recesses that are oriented differently. By means of the recesses, the size of the surface on which the roller contacts the adapter element is reduced, so that friction is reduced.

According to a further aspect of the invention, a locking system for an insulating door is proposed, with an actuator that is rotatable about an actuating axis, whereby on an element of the locking system, a roller tongue according to the present invention is secured, such that the pin of the roller tongue is oriented transverse to the actuating axis and is pivotable by actuation about the actuating axis between an opened position and a closed position. The insulating door, in particular, is used for closing a temperature-controlled chamber, for example, of a housing of the air conditioning, ventilation and/or heating assembly, whereby between the insulating door and a door frame, a seal is arranged. The roller tongue is arranged on the locking system, such that the roller tongue engages in the closed position of the locking system, a door wing or frame, whereby the insulating door is closed. By moving the actuator into its opened position, during which the roller is rolled over the door wing or frame, the roller tongue is brought into in orientation in which the insulating door can be opened.

In one embodiment, the actuator has a handle and the pin of the roller tongue is attached directly to the handle. This arrangement is preferred, in particular, when the insulating door is opened inwardly and the handle is arranged on the outside of the insulating door.

Alternatively, it also can be provided that an actuating shaft coupled with the actuator can be positioned in the mounted state on a backside of the door and the roller tongue is secured to the actuating shaft. This embodiment is preferred when the insulating door opens outwardly.

### BRIEF DESCRIPTION OF THE DRAWINGS

The invention and the technical environment are explained next with reference to the figures. In the figures:

FIG. 1 shows an actuator with a roller tongue;

FIG. 2 shows an exploded view; and

FIG. 3 shows a sectional view through the roller tongue.

### DETAILED DESCRIPTION OF THE PREFERRED EMBODIMENTS

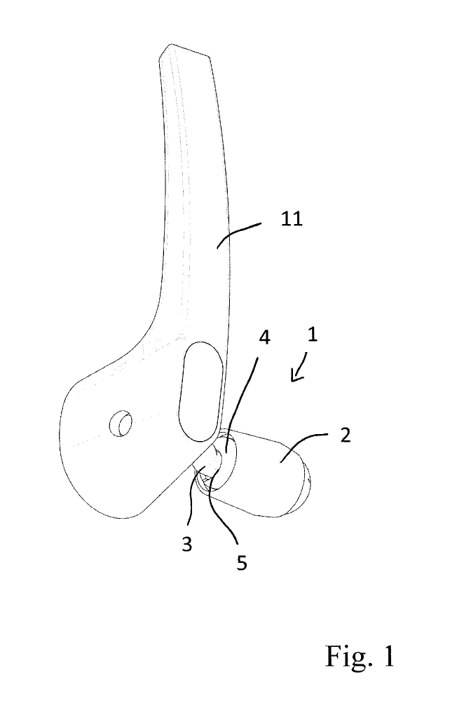

FIG. 1 shows elements of a locking system for an insulating door, which includes an actuator 11 having a handle. The actuator 11 is coupled with an actuator shaft (not shown), whereby the actuator 11 is rotatable about an actuating axis for opening and closing the locking system.

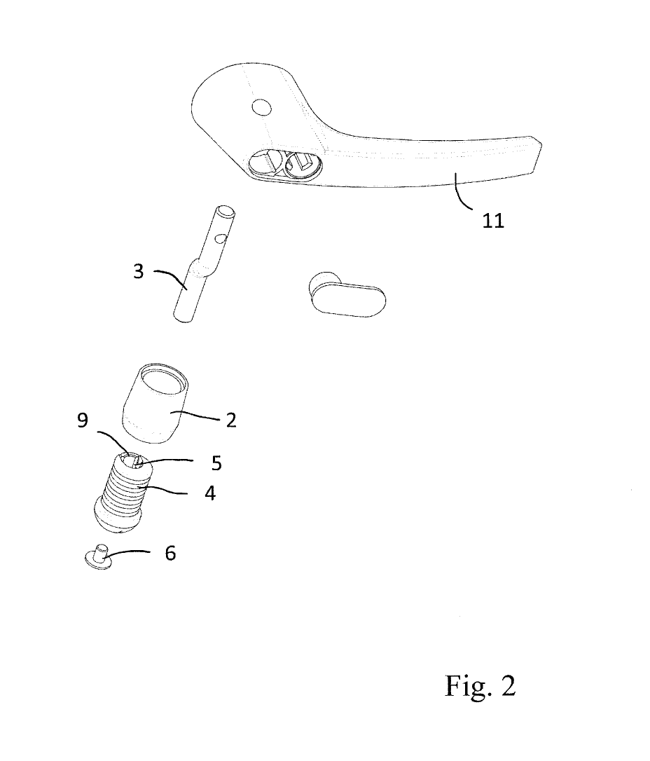

A roller tongue 1 is mounted to the actuator 11. The roller tongue shown in an exploded view in FIG. 2 includes a pin 3 and an adapter element 4 that is displaceable with a receiver 5 on the pin 3. A roller 2 is rotatably mounted on the adapter element 4.

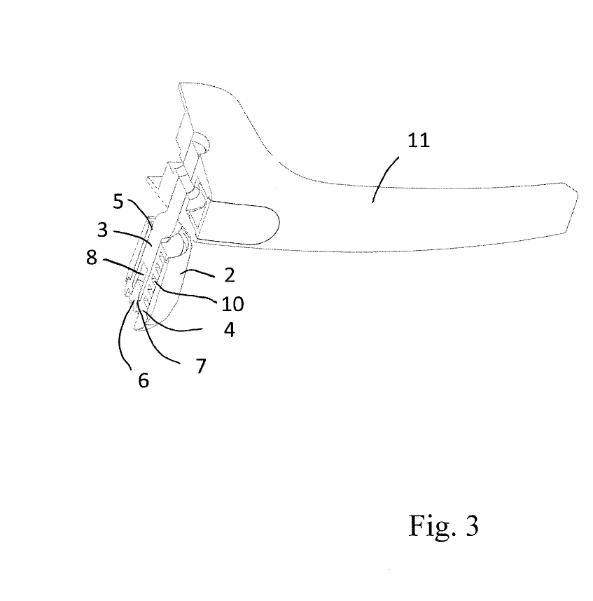

The receiver 4 is arranged eccentrically on a cylindrical section of the adapter element 4, on which the roller is rotatably mounted. The adapter element 4 can be fixed to the pin 3 in different rotational positions by means of an attachment element 6 formed as a screw. The attachment element 6 engages through a hole 7 in a face of the adapter element 4 in a recess 8 formed as an inner threading on a corresponding face of the pin (see FIG. 3). Depending on the orientation of the adapter element 4 to the pin, the roller 2 rotatably mounted on the adapter element 4, therefore, has different distances or spacing relative to a door surface.

For reducing the friction between the roller 2 and the adapter element 4, the adapter element 4 has multiple recesses 10.

In addition, the adapter element 4 has a snap element 9, which is elastically moveable or deflectable into the receiver 5. Based on the start up angle on the snap element 9, this is moved onto the adapter element upon displacement of the roller 2 and snaps back after reaching the mounting position, whereby the snap element 9 prevents the roller 2 from sliding off the adapter element 4 into the re-spring-loaded position, so that it cannot be lost inadvertently. On the other hand, a more simple exchange is possible, since, to take down the roller from the adapter element 4, the snap element can be manually displaced.

The locking system, in particular, is mounted to an insulating door, such that in a closed position, a doorframe is engaged behind by the roller tongue 1. During opening or closing process, the roller 2 rolls over the surface of the door frame, so that only a minimal resistance is provided. In an opened position, the rear grip, or tongue and groove engagement, is disengaged, so that the insulating door can be opened. With the roller tongue, the distance of the roller 2 to the door surface can be changed simply and also a later time.

The specification incorporates by reference the disclosure of EP 17 153 467.0, filed Jan. 27, 2017.

The present invention is, of course, in no way restricted to the specific disclosure of the specification and drawings, but also encompasses any modifications within the scope of the appended claims.

### REFERENCE NUMERAL LIST

1 roller tongue
2 roller
3 pin
4 adapter element
5 receiver
6 attachment element
7 hole
8 recess
9 snap element
10 receiver
11 actuator

We claim:

1. A roller tongue (1) for a locking system, comprising:
a spindle attachable to the locking system; and
a roller (2) rotatably mounted on the spindle, wherein the spindle comprises multiple parts and includes a pin (3) and an adapter element (4), wherein the adapter element (4) includes a receiver (5) for the pin (3) arranged eccentrically in the adapter element (4), and wherein the adapter element (4) is fixable to the pin (3) in different orientations.

2. The roller tongue (1) according to claim 1, wherein the adapter element (4) is attachable to the pin (3) via an attachment element (6), the attachment element being configured to prevent a rotation of the adapter element (4) relative to the pin (3).

3. The roller tongue according to claim 1, wherein the adapter element (4) is securable to the pin (3) via of an attachment element (6), wherein the attachment element (6) is configured to delimit an axial movement of the adapter element (4) on the pin (3).

4. The roller tongue according to claim 1, wherein the roller (2) is rotatably mounted on the adapter element (4) and is secured to the adapter element (4) against axial movement via a radially actuatable snap element (9).

5. The roller tongue (1) according to claim 1, wherein the roller (2) is rotatably mounted to the adapter element (4) and the adapter element (4) has multiple receivers running in a circumferential direction.

6. A locking system for an insulating door, comprising:
an actuator (11) rotatable about an actuating axis;
a roller tongue (1) according to claim 1, wherein the roller tongue is secured to an element of the lock system, such that the pin (3) is oriented transverse to the actuating axis and is pivotable by means of the actuator (11) about the actuating axis between an opened position and a closed position.

7. The locking system according to claim 6, wherein the actuator (11) is formed as a handle and the pin (3) of the roller tongue (1) is secured directly to the handle.

8. The locking system according to claim 6, wherein an actuating shaft coupled with the actuator (11) is arranged in a mounted state on a backside of a door and the roller tongue (1) is secured to the actuating shaft.
